(19) United States
(12) Patent Application Publication
(10) Pub. No.: US 2011/0097589 A1
(43) Pub. Date: Apr. 28, 2011

(54) ARTICLE FOR HIGH TEMPERATURE SERVICE

(75) Inventors: Peter Joel Meschter, Niskayuna, NY (US); Krishan Lal Luthra, Niskayuna, NY (US); Curtis Alan Johnson, Niskayuna, NY (US)

(73) Assignee: GENERAL ELECTRIC COMPANY, Schenectady, NY (US)

(21) Appl. No.: 12/607,096

(22) Filed: Oct. 28, 2009

(51) Int. Cl. B32B 17/06

(52) U.S. Cl. 428/428

(57) ABSTRACT

An article for use at high temperature, such as a component for a gas turbine assembly, is presented. The article comprises a substrate comprising silicon; a bondcoat disposed over the substrate, wherein the bondcoat comprises a silicide of a platinum-group metal; and a topcoat disposed over the bondcoat, wherein the topcoat comprises a ceramic material.

### BACKGROUND

This invention relates to high-temperature machine components. More particularly, this invention relates to coating systems for protecting machine components from exposure to high-temperature environments. This invention also relates to methods for protecting articles.

High-temperature materials, such as, for example, ceramics, alloys, and intermetallics, offer attractive properties for use in structures designed for service at high temperatures in such applications as gas turbine engines, heat exchangers, and internal combustion engines, for example. However, the environments characteristic of these applications often contain reactive species, such as water vapor, which at high temperatures may cause significant degradation of the material structure. For example, water vapor has been shown to cause significant surface recession and mass loss in silicon-bearing materials. The water vapor reacts with the structural material at high temperatures to form volatile silicon-containing species, often resulting in unacceptably high recession rates.

Environmental barrier coatings (EBC's) are applied to silicon-bearing materials and other material susceptible to attack by reactive species, such as high temperature water vapor; EBC's provide protection by prohibiting contact between the environment and the surface of the material. EBC's applied to silicon-bearing materials, for example, are designed to be relatively stable chemically in high-temperature, water vapor-containing environments. One exemplary conventional EBC system, as described in U.S. Pat. No. 6,410,148, comprises a silicon or silica bond layer (also referred to herein as a “bondcoat”) applied to a silicon-bearing substrate; an intermediate layer comprising mullite or a mullite-alkaline earth aluminosilicate mixture deposited over the bond layer; and a top layer comprising an alkaline earth aluminosilicate deposited over the intermediate layer. In another example, U.S. Pat. No. 6,296,941, the top layer is a yttrium silicate layer rather than an aluminosilicate.

The above coating systems can provide suitable protection for articles in demanding environments, but opportunities for improvement in coating performance exist. For instance, the presence of free silicon in the bond layer may restrict the maximum rated material temperature for a coated component to avoid melting of the silicon and resultant mechanical instability of the bond layer. Improvements in the quality of engineered structural materials, such as silicon-bearing ceramics and ceramic matrix composites, have enhanced the high temperature capability of these materials to the point where the melting point of the silicon in the EBC bond layer has become a limiting factor for the use of such materials in high-temperature structural applications.

Therefore, there remains a need in the art for EBC bond layers with temperature capability that exceeds that of conventional bond layers. There is also a need for machine components employing coating systems that incorporate an improved bond layer to enhance their high-temperature capability.

### BRIEF DESCRIPTION

Embodiments of the present invention are provided to meet these and other needs. One embodiment is an article for use at high temperature. The article comprises a substrate comprising silicon; a bondcoat disposed over the substrate, wherein the bondcoat comprises a silicide of a platinum-group metal; and a topcoat disposed over the bondcoat, wherein the topcoat comprises a ceramic material.

Another embodiment is an article for use at high temperature. The article comprises a substrate comprising a ceramic matrix composite material, the material comprising silicon; a bondcoat disposed over the substrate, wherein the bondcoat comprises a silicide of rhenium, ruthenium, osmium, rhodium, iridium, or a combination including any one or more of the foregoing; and a topcoat disposed over the bondcoat, wherein the topcoat comprises an aluminate, a silicate, an aluminosilicate, or yttria stabilized zirconia.

### DETAILED DESCRIPTION

According to one embodiment of the present invention, an article for use at high temperature comprises a substrate, a bondcoat disposed over the substrate, and a topcoat disposed over the bondcoat. The bondcoat and topcoat may be parts of a multilayered EBC system designed to protect the substrate from high-temperature environments. Examples of such an article include, for example, a component of a gas turbine assembly, such as, but not limited to, a blade, vane, shroud, or combustor liner. Because the efficiency of a gas turbine generally increases as a function of the firing temperature, having components capable of operation at increased temperatures may offer benefits leading to enhanced fuel economy and reduced emissions.

The bondcoat is generally disposed on the surface of the substrate, and functions to prevent deleterious oxidation reactions from occurring at the substrate/coating interface. In accordance with embodiments of the present invention, the bondcoat comprises a silicide of a platinum-group metal. The platinum-group metals, for the purposes of this description, include rhenium, ruthenium, rhodium, palladium, osmium, iridium, and platinum. These elements form silicides having melting points that are higher than the melting point of silicon, and have oxidation resistance comparable to that of silicon. The silicide material may be present in any volume fraction of the bondcoat as is appropriate for a particular application. In some embodiments, at least about 50% of the volume of the bondcoat is silicide material; in some embodiments, this fraction is at least about 80%, and in certain embodiments this fraction is about 100% (excluding incidental materials that may exist in the coating as a result of processing, defects, and the like). It should be noted that many platinum-group metals form multiple types of silicide phases in the presence of silicon, depending on the relative amounts of silicon and metal present, and the temperature. Unless specifically stated otherwise, the term “silicide” refers to any and all of the possibly several phases that may be formed by a given metal-silicon composition, and these phases may be thermodynamically stable or metastable phases.

Silicide compounds have been described previously in the art. For example, in U.S. Pat. No. 7,300,702, tantalum silicide or molybdenum silicide may be used as an “isolation layer” in a multilayered protective coating system for silicon-bearing substrates. U.S. Pat. No. 7,354,651 describes an EBC system having a bond layer that includes a silicide of one or more of chromium, tantalum, titanium, tungsten, zirconium, hafnium, or a rare earth. The particular silicide compounds mentioned in these references may be effective in certain applications, but the platinum-group metal silicides offer unique chemical properties at high temperatures that distinguish them from other silicides as EBC bondcoat materials. For example, when a silicide of a transition metal such as hafnium or tantalum is oxidized, both the silicon and the transition metal may be incorporated into the oxide reaction product, because both materials are reactive with oxygen in the relevant temperature range. Pure silicon oxide (silica) is a desirable reaction product due to its slow reaction kinetics, high thermodynamic stability, and adherent, protective characteristics. However, the incorporation of other cations may degrade the characteristics of the oxide product. Moreover, the incorporation of the metal cation into the oxide depletes the bondcoat of this species, potentially degrading the oxidation resistance of the remaining material.

On the other hand, the platinum-group metal silicides as used in accordance with embodiments of the present invention do not behave as described above. Instead, a platinum-group metal silicide will typically oxidize to form pure silica throughout the service life of the coating, because under typical conditions the platinum-group metal will not form a stable oxide. In particular, the establishment of a continuous SiO2 layer over the silicide bondcoat maintains a partial pressure or chemical potential of oxygen at the bondcoat/oxide at a level that is too low to cause the Pt group metal to oxidize. Under such conditions, the metal cation cannot be incorporated into the oxide reaction product, nor is it removed as a volatile reaction product. As a result, the distinctly different chemical properties of platinum-group metal silicides may lead to very different and more desirable behavior as bondcoat materials in EBC systems, even in comparison to other silicide materials.

While all of the platinum-group metal silicides may be useful as described herein, the expected service temperature is a significant factor in selecting any particular composition. In particular embodiments, the bondcoat comprises a silicide of rhenium, ruthenium, osmium, rhodium, iridium, or a combination including any one or more of the foregoing. These silicides have desirable high-temperature properties, and their decomposition products that may form during service time at high temperatures are not likely to form alloys or compounds with undesirably low melting points. For example, small amounts of silicon significantly depress the melting points of platinum and palladium, and may promote the formation of phases with melting points below a temperature that is acceptable for a particular embodiment. On the other hand, rhenium-rich alloys with silicon retain high incipient melting temperatures. For example, for binary rhenium-silicon alloys with up to 64 atomic percent silicon, no liquid phase is expected to be present below about 1710 degrees Celsius, whereas comparable platinum-silicon alloys may begin to melt below 1000 degrees Celsius. In certain embodiments, the bondcoat consists essentially of a silicide of rhenium, ruthenium, osmium, rhodium, iridium, or a combination including any one or more of the foregoing, and in particular embodiments, the bondcoat consists essentially of rhenium silicide. Here, the term “consists essentially of a silicide” means that the bondcoat contains primarily silicon and the metal species as noted, generally in the form of one or more silicide phases, and that other phases present in the bondcoat are incidental and do not adversely effect the melting point or oxidation resistant properties of the bondcoat.

In some embodiments, the selected silicide phase or phases include the most Si-rich compounds in the respective binary Pt group metal-Si systems, because the Si content, and thus the time before the bondcoat is oxidized through, are at their maximum values. Examples include OsSi₂, ReSi_{1.8}, and Ru₂Si₃. However, in particular cases this consideration is weighed against any undesirably low-melting point regions of the respective phase diagrams. For example, in the iridium-silicon system, silicides having more than about 50 atomic percent silicon tend to have melting points below that of elemental silicon, and so in certain embodiments, where an enhancement is desirable, IrSi may be selected over other iridium silicide compositions of higher silicon content, because of its higher melting point.

In some embodiments, where long-term service under very high temperature requirements is required, the composition of the bondcoat is selected to meet two specific functional criteria. First, the particular metal-silicon composition is selected so that the melting temperature of the coating as initially applied provides significant enhancement, such as greater than 100 degrees Celsius, over the melting point of pure silicon (1414 degrees Celsius). Second, the composition is selected such that this enhanced high-temperature performance is sustainable and robust over the service life of the coating, in that a melting temperature of the increasingly silicon-depleted bondcoat remaining as the bondcoat oxidizes remains substantially above the 1414 degrees Celsius level, such as above at least 1500 degrees Celsius. Examples of compositions that meet these two criteria include rhenium-silicon, where the atomic fraction of silicon is less than about 0.64; ruthenium-silicon, where the atomic fraction of silicon is less than about 0.6, and in particular embodiments less than or equal to 0.25; osmium silicon, where the atomic fraction of silicon is less than about 0.67; and iridium-silicon, where the atomic fraction of silicon is less than or equal to 0.25. It should be noted that the above atomic fraction numbers refer to the atomic fraction of silicon relative to the total amount of platinum-group metal atoms in the coating plus silicon atoms present as elemental silicon plus silicon atoms present in platinum-group metal silicides. As above, these embodiments include instances where the bondcoat consists essentially of a platinum group metal and silicon, present as one or more silicides, and possibly, though not necessarily, including some amount of metallic platinum-group material and/or silicon oxide.

The lower limit of silicon in each exemplary composition range described herein depends in part on the desired quantity of silicon available in the bondcoat to provide oxidation resistance. In all cases at least an effective amount of silicon is present, meaning an amount capable of forming an oxide upon exposure of the bondcoat to oxidative species such as oxygen or water vapor at temperatures above 500 degrees Celsius. The effective amount for any particular composition system is readily ascertainable by one skilled in the art via simple oxidation experiments. In some embodiments a lower range limit is about 0.5 atomic percent silicon; in certain instances this lower range limit is about 1 atomic percent silicon, and in particular embodiments this lower range limit is about 5 atomic percent silicon. In certain embodiments, a higher minimum amount of silicon is specified to provide for a larger silicon “reservoir” within the coating, and in such embodiments the lower limit of silicon is about 10 atomic percent, and about 25 atomic percent in some embodiments.

The bondcoat described herein may be applied by any of several methods used to deposit coatings, including chemical vapor deposition (CVD), physical vapor deposition (PVD), and thermal spray techniques, all of which are well known in the coating arts. The thickness of the bondcoat is comparable to that used in other EBC systems. For instance, in some embodiments the bond coat has a thickness of up to about 250 micrometers. In certain embodiments, this thickness is in the range from about 50 micrometers to about 150 micrometers, and in particular embodiments the thickness is in the range from about 80 micrometers to about 120 micrometers.

The bondcoat is applied to a substrate that comprises silicon. The substrate may comprise a ceramic compound, metal alloy, intermetallic compound, or combinations of these. Examples of intermetallic compounds include, but are not limited to, niobium silicide and molybdenum silicide. Examples of suitable ceramic compounds include, but are not limited to, silicon carbide, molybdenum disilicide, and silicon nitride. Embodiments of the present invention include those in which the substrate comprises a ceramic matrix composite (CMC) material. CMC's typically comprise a matrix phase and a reinforcement phase embedded in the matrix phase. The CMC may be any material of this type, including composites in which the CMC matrix phase and reinforcement phase both comprise silicon carbide. Regardless of material composition, in some embodiments the substrate comprises a component of a turbine assembly, such as, among other components, a combustor component, a shroud, a turbine blade, or a turbine vane.

A topcoat is disposed over the bondcoat. Intermediate coatings may be disposed between the topcoat and the bondcoat in some embodiments, to enhance the protection, mitigate thermally generated stresses, or otherwise improve the performance of the coating system. The topcoat comprises a ceramic material. This coating is the outermost coating of the article in some embodiments, but in other embodiments the topcoat is disposed beneath one or more outer coatings. In some embodiments, the function of the topcoat is to provide a recession-resistant barrier to water vapor at high temperatures. Accordingly, any material that provides such a barrier may be suitable for use as a topcoat. In certain embodiments, the topcoat comprises an aluminate, a silicate, an aluminosilicate, or some combination including one or more of these; such compounds are known in the art for their effectiveness as recession resistant coatings. Examples of topcoat compositions include aluminates, silicates, and aluminosilicates of alkaline earth elements, yttrium, scandium, or the rare earth elements. Specific examples include barium strontium aluminosilicate, and yttrium silicates. In alternative embodiments, the function of the topcoat is to provide thermal protection for the substrate. Ceramic thermal barrier coatings (TBC's) are well known in the art for use in high temperature protection of engineered components. Stabilized zirconia, such as yttria-stabilized zirconia, is a prominent example of coatings of this type, and is suitable for use as the topcoat in some embodiments of the present invention. Finally, in some embodiments, an outer layer of TBC is disposed over a topcoat of one or more of the recession resistant coatings described above.

The topcoat described herein, like the bondcoat described previously, may be applied by any of several methods used to deposit coatings, including chemical vapor deposition (CVD), physical vapor deposition (PVD), and thermal spray techniques. The thickness of the topcoat is comparable to that used in other EBC systems, and is generally selected to provide adequate protection for the particular environment and desired service life of the substrate being coated. In certain embodiments, the coating has a thickness of greater than about 25 micrometers. In particular embodiments, the thickness is in the range from about 125 micrometers to about 500 micrometers.

In a particular embodiment, an article for high temperature service, such as a component of a gas turbine assembly, comprises a substrate comprising a silicon-bearing, ceramic matrix composite material; a bondcoat disposed over the substrate, wherein the bondcoat comprises a silicide of rhenium, ruthenium, osmium, rhodium, iridium, or a combination including any one or more of the foregoing; and a topcoat disposed over the bondcoat, wherein the topcoat comprises an aluminate, a silicate, an aluminosilicate, or yttria-stabilized zirconia.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article for use at high temperature, comprising:
a substrate comprising silicon;
a bondcoat disposed over the substrate, wherein the bondcoat comprises a silicide of a platinum-group metal; and
a topcoat disposed over the bondcoat, wherein the topcoat comprises a ceramic material.

2. The article of claim 1, wherein the bondcoat comprises a silicide of rhenium, ruthenium, osmium, rhodium, iridium, or a combination including any one or more of the foregoing.

3. The article of claim 1, wherein the bondcoat comprises rhenium and silicon, where the atomic fraction of silicon is less than about 0.64.

4. The article of claim 1, wherein the bondcoat comprises ruthenium and silicon, where the atomic fraction of silicon is less than about 0.6.

5. The article of claim 4, wherein the atomic fraction of silicon is less than or equal to 0.25.

6. The article of claim 1, wherein the bondcoat comprises osmium and silicon, where the atomic fraction of silicon is less than about 0.67.

7. The article of claim 1, wherein the bondcoat comprises iridium and silicon, where the atomic fraction of silicon is less than or equal to 0.25.

8. The article of claim 1, wherein the ceramic material comprises an oxide.

9. The article of claim 1, wherein the ceramic material comprises an aluminate, a silicate, an aluminosilicate, or yttria stabilized zirconia.

10. The article of claim 1, wherein the substrate comprises at least one material selected from the group consisting of silicon nitride, molybdenum disilicide, and silicon carbide.

11. The article of claim 1, wherein the substrate comprises a ceramic matrix composite material.

12. The article of claim 11, wherein the composite comprises a matrix phase and a reinforcement phase, and wherein the matrix phase and the reinforcement phase comprise silicon carbide.

13. The article of claim 1, wherein the article comprises a component of a gas turbine assembly.

14. An article for use at high temperature, comprising:
a substrate comprising a ceramic matrix composite material, the material comprising silicon;
a bondcoat disposed over the substrate, wherein the bondcoat comprises a silicide of rhenium, ruthenium, osmium, rhodium, iridium, or a combination including any one or more of the foregoing; and
a topcoat disposed over the bondcoat, wherein the topcoat comprises an aluminate, a silicate, an aluminosilicate, or yttria stabilized zirconia.
